(19) United States
(12) Patent Application Publication
(10) Pub. No.: US 2007/0097177 A1
(43) Pub. Date: May 3, 2007

(54) Droplet ejection device and method using electrostatic field

(75) Inventors: Suk-Han Lee, Suwon-si (KR); Han-Seo Ko, Suwon-si (KR); Do-Young Byun, Seoul (KR); Sang-Joon Han, Suwon-si (KR); Yong-Jae Kim, Suwon-si (KR); Sang-Uk Son, Suwon-si (KR); Jung-Taek Oh, Suwon-si (KR); Ji-Hye Yang, Seoul (KR)

Correspondence Address: FOLEY AND LARDNER LLP;SUITE 500, 3000 K STREET NW, WASHINGTON, DC, 20007, US

(73) Assignee: Sungkyunkwan University Foundation for Corporate Collaboration

(21) Appl. No.: 11/260,689

(22) Filed: Oct. 28, 2005

(51) Int. Cl. B41J 2/06

(52) U.S. Cl. 347/55

(57) ABSTRACT

Disclosed are a droplet ejection device and method using an electrostatic field. The droplet ejection method includes: setting a separate electric field direction in each of a plurality of nozzles; supplying one of ink and ink containing particles to each nozzle; and forming and ejecting a plurality of separate ink droplets. The droplet ejection device includes a deposition part having electrode layers and insulating layers deposited toward a nozzle. Therefore, it is possible to readily perform droplet ejection without a heater or diaphragm vibration device. In addition, it is possible to reduce impact applied to the ink and obtain good print quality, since the ink is ejected using the electrostatic field.

### BACKGROUND OF THE INVENTION

1. Field of the invention

The present invention relates to a droplet ejection device and method using an electrostatic field, and more particularly, to a droplet ejection device and method for generating a specific electric field at a surface of ink adjacent to a nozzle to eject the ink.

2. Description of the Prior Art

A conventional droplet ejection device used in an inkjet printer has a structure that ejects ink using a heater or diaphragm vibration device installed at an inkjet head.

Hereinafter, an example of the inkjet printer using the heater will be briefly described.

First, when current flows through an electrode installed at the heater, heat is generated from the heater, and the heat is sequentially conducted to a protection layer into which the ink is absorbed. When the ink is heated by the conducted heat to generate bubbles, a volume of an upper part of the ink is varied due to the bubbles so that the upper part of the ink is pushed out through an opening formed at a nozzle plate.

As a result, the ink expanded and discharged to the exterior of the nozzle plate is ejected on paper in a droplet shape due to surface tension.

However, such a conventional droplet ejection device has problems of generating a thermal change in the ink due to the heating process for generating bubbles, and degrading print quality due to sudden internal volume variations.

### SUMMARY OF THE INVENTION

Therefore, the present invention has been made in view of the above-mentioned problems, and it is an object of the present invention to provide a droplet ejection device and method capable of upgrading print quality by enabling a new concept of flow control using an electrostatic field.

In order to accomplish the above object, there is provided a method of ejecting ink using an electrostatic field including: setting an electric field direction toward a discharge port of the nozzle, supplying ink or ink containing particles to a nozzle, and forming and ejecting an ink droplet.

In addition, a droplet ejection device including a nozzle in accordance with the present invention includes a deposition part having electrode layers and insulating layers, which are deposited toward the nozzle.

Preferably, each of the deposited electrode layers is connected to a separated power source to adjust the direction of an electric filed.

In addition, preferably, the formation of the droplet is controlled through a coating part continuously composed of a hydrophilic material and a hydrophobic material in the nozzle.

In addition, the formation and ejection of the droplet may be controlled by adjusting the magnitude of a voltage applied to the separate power source in a time-based manner.

Meanwhile, another method of ejecting ink using an electrostatic field in accordance with the present invention includes: setting a separate electric field direction in each of a plurality of nozzles, supplying ink or ink containing particles to the plurality of nozzles, and forming and ejecting a plurality of separate droplets.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a front cross-sectional view of the structure of a droplet ejection device using an electrostatic field in accordance with the present invention;

FIG. 2 is a conceptual view showing the theory that particles have charges;

FIG. 3 is a view showing an electric field formed around an ink surface in accordance with an embodiment of the present invention;

FIG. 4 is a conceptual view showing the theory that an electrostatic field is formed in accordance with the present invention;

FIG. 5 is a conceptual view showing the theory that a voltage applied to a nozzle of a droplet ejection device in accordance with the present invention is adjusted;

FIG. 6 is a view illustrating a coating part and a droplet ejection state of an inner surface of a nozzle in FIG. 1,(a) of which is before supplying a voltage and (b) of which is after supplying the voltage;

FIG. 7 is a conceptual view showing a process of calculating and estimating a minimum allowable time of an adjustment period when a voltage applied to a nozzle of a droplet ejection device in accordance with the present invention is adjusted; and

FIG. 8 is a diagram showing a relationship of time and adjusted magnitudes of voltages applied to a nozzle of a droplet ejection device in order to induce droplet ejection in accordance with the present invention.

### DETAILED DESCRIPTION OF THE PREFERRED EMBODIMENTS

Hereinafter, an exemplary embodiment of the present invention will be described in conjunction with the accompanying drawings.

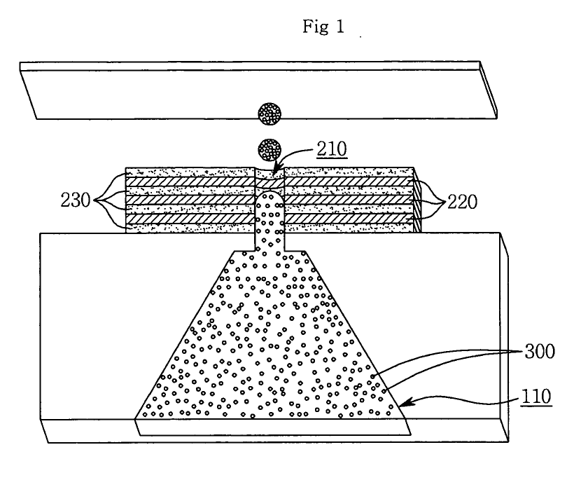

FIG. 1 illustrates a droplet ejection device using an electrostatic field in accordance with the present invention.

As shown in FIG. 1, the droplet ejection device using an electrostatic field in accordance with the present invention includes a chamber 110 for storing ink 300, and a print head having a nozzle 210 formed at the chamber 110.

In addition, a deposition part having electrode layers 220 and insulting layers 230, which are alternately deposited around the nozzle 210, is installed in a direction extending from the nozzle 210. The electrode layer 220 may be formed of aluminum and so on, and the insulating layer 230 may be formed of Si₃N₄ and so on.

Further, each of the electrode layers 220 is connected to a separate power source, thereby setting the voltage magnitude according to a predetermined control signal and adjusting an electric field direction around the nozzle 210 within a predetermined range.

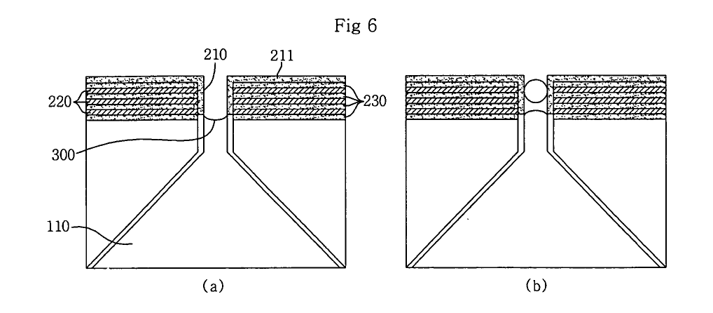

As shown in FIG. 6, a coating part 211 continuously composed of a hydrophilic material and a hydrophobic material may be applied to an inner surface of the nozzle 210. The hydrophilic material may be formed of SiO2, and the hydrophobic material may be formed of Teflon, silicon or the like. Therefore, it is possible to control the formation of droplets using instability on the transition from hydrophilicity to hydrophobicity. In this instable state, an external electric filed applies repulsive force to meniscus (a concave surface of the ink surface) to take a droplet away.

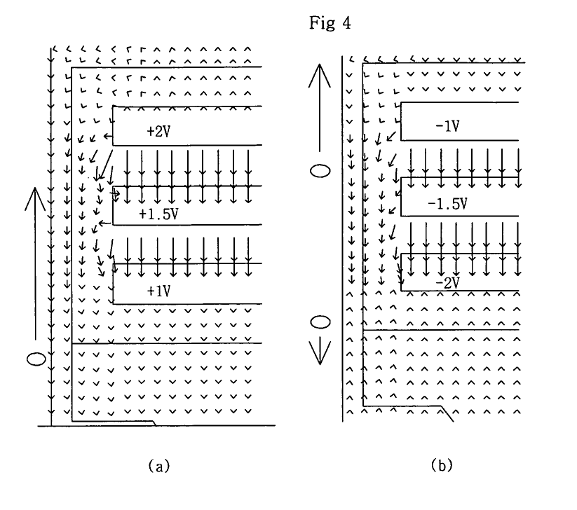

Meanwhile, as shown in FIG. 4, each of the deposited electrode layers 220 is connected to the separate power source having a voltage that becomes larger toward a discharge port of the nozzle 210.

Hereinafter, operation and theory of the present invention will be described.

Briefly describing, the present invention is character in that fluid can be smoothly discharged by applying different voltages to electrodes deposited around a nozzle in a state that general ink or nano fluid having charges is contained in a chamber.

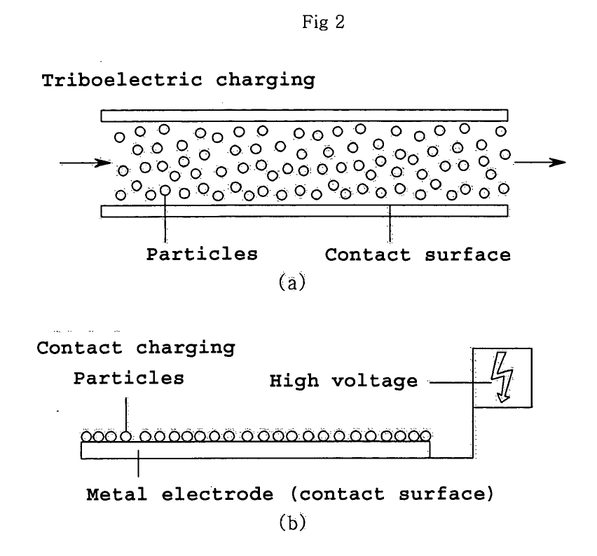

In particular, when the nano fluid has charges, as shown in FIG. 2, the charges can be charged by triboelectric charging or contact charging, which are briefly described hereinafter.

1) Triboelectric charging (see FIG. 2a)

When electric neutral insulating bodies having different electrostatic properties are in contact with each other, charges are transmitted from one surface to the other surface in order to obtain thermodynamic equilibrium (i.e., to reduce a chemical potential difference). At this time, when the surfaces are rapidly separated from each other due to sliding or rubbing, excessive charges remain on the surfaces. Particles are charged by a collision with a rotating agitator used to disperse powder. Therefore, when the triboelectric charging is performed in liquid nitrogen, the charging and powder dispersion can be simultaneously performed using a high shear agitating system.

2) Contact charging (see FIG. 2b)

Floating matters are spouted out through a grid-shaped metal electrode connected to a high voltage supplier, and charges are transmitted from the electrode to particles due to a potential difference at this time.

As a result of researches, it is appreciated that the triboelectric charging is effective to charge more surface charges than the contact charging.

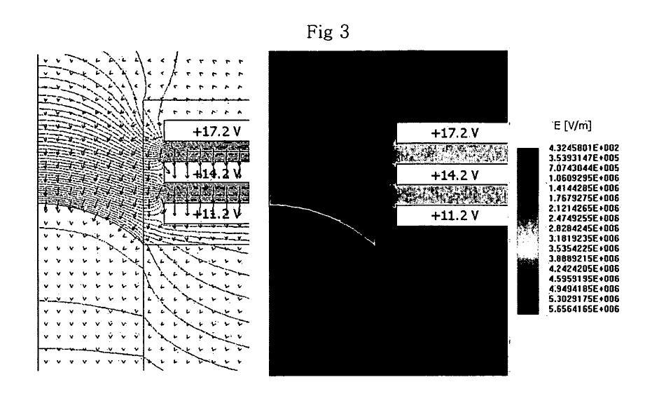

Hereinafter, a process of ejecting ink from a nozzle will be described with reference to FIGS. 3 and 4.

An electric field formed around the nozzle varies depending on arrangement of drive electrodes and magnitude of voltage, and the magnitude and direction of electrostatic force also vary depending on positions of fluid and shapes of a fluid surface. Therefore, first, in consideration of basic arrangement of the electrodes of the nozzle, an appropriate model was selected.

The model has a structure that a bottom surface of a chamber is a reference potential, and three electrodes are deposited around the nozzle in a certain interval to adjust voltage of each electrode. At this time, the magnitude and direction of the electrostatic field are determined at a center of a nozzle inlet depending on voltages applied to the electrodes. As shown in FIG. 3, when charges of nano particles distributed in the fluid are negative, an upper electrode should have a thickness larger than a lower electrode since the direction of the electrostatic field should be oriented inside the chamber located at a lower side with reference to the nozzle inlet in order to induce conveyance of particles to the exterior of the nozzle.

In this process, a main region for moving the fluid is located under the fluid surface and has an electric field smaller than that of an air region of the exterior of the nozzle due to mediun properties of the fluid. In particular, a large electric field formed outside the fluid surface as shown in FIG. 3 does not perform a great role to move the fluid.

FIG. 4 illustrates an electric field affecting the fluid when various magnitudes of voltages applied to electrodes around the nozzle inlet.

FIG. 4a shows a typical voltage condition that the fluid flows from inside the chamber toward the discharge port. In particular, the electric field at the discharge port of the nozzle has a large magnitude to apply more pressure to the fluid.

FIG. 4b shows the case when a direction of the electric field is reversed by 180° by applying negative voltages to all three electrodes. Here, the upper electrode has a negative voltage smaller than that of the lower electrode so that a small part of the fluid pulled up to a surface of the discharge port is separated from the fluid to be ejected to the air.

The electrodes are operated using the above two typical methods as a basic control process to thereby smoothly induce formation and ejection of the ink droplet

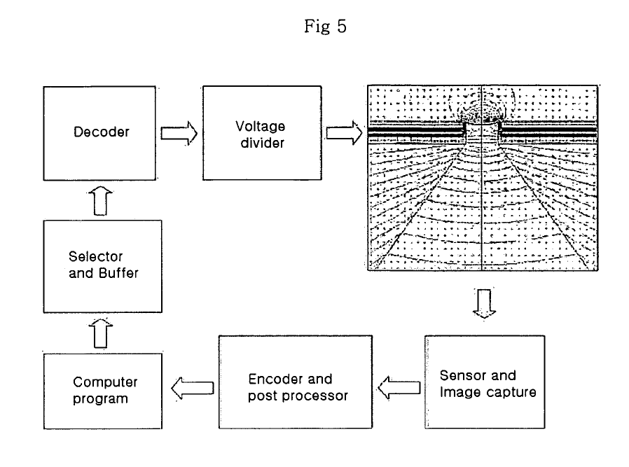

Meanwhile, FIGS. 5, 7 and 8 illustrate a theory that the voltages applied to the separated voltage sources are adjusted in a time-based manner to control formation and rejection of the ink droplet, which will be briefly described hereinafter.

FIG. 5 illustrates an example of a device adapted to adjust the voltages in accordance with the present invention.

Basically, the voltages are automatically controlled by a computer program. As shown in FIG. 4, since the ink droplet is instantly conveyed and ejected, it is necessary to test and develop a device for controlling the ejection, to use a commercially available computer to adapt an application system, and to employ a microprocessor for mass production.

First, all processes are programmed using the computer, and a voltage of each separate voltage device is set through an external interface using a selector, a buffer and a decoder in a digital manner. After setting the voltages of the voltage device, the voltages are simultaneously applied to the deposited electrodes.

The above process may be performed by a single order parameter of a main program in a bundle, and adjustment and setting time of each separate voltage may be changed as a selectivity factor of the order parameter, thereby more freely and actively adjusting each of the separate power sources.

In addition, in order to confirm the operated result and find the optimal setting condition, a device for high-speed photographing an ejection operation of the nozzle and feed-backing the operation to the computer may be adapted. At this time, while a high speed photographing device may be used for a test, the device may be implemented through a sensor in the case of adapting to a real application device.

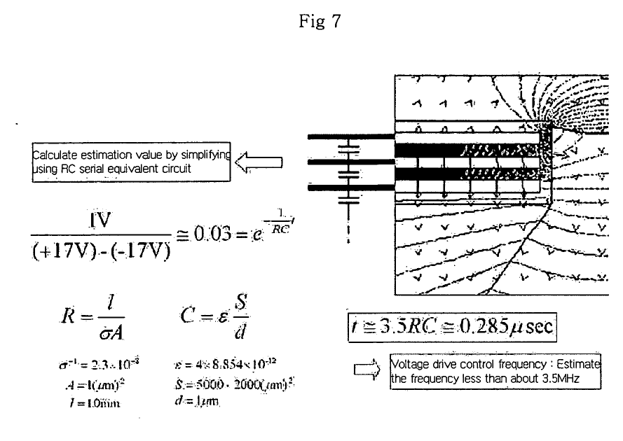

In this process, it is required to estimate a minimum continuous time of voltage adjustment available in the nozzle structure in accordance with the present invention, as shown in FIG. 7.

First, the deposited electrodes can be simulated using capacitance of a basic circuit device, and the simulated value is calculated according to a well-known equation of capacitance. In addition, after calculating using a well-known equation of resistance according to a conductor structure from the exterior of the nozzle to the electrode, a time constant according to a ratio of voltage differences applied in the simulation is calculated to obtain a voltage increase or drop delay time generated when the voltage differences are generated.

According to the result, when the delay time is about 0.285 μsec, and a time for maintaining the voltage setting is sufficiently large, the voltage may be readily adjusted.

In addition, a voltage adjustment frequency less than about 3.5MHz is estimated, which is a sufficiently large frequency in comparison with a flow phase of the ink.

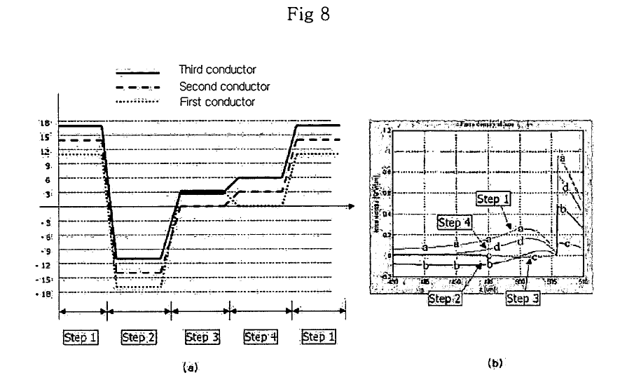

FIG. 8 illustrates an example that voltages applied to the separate power sources are varied through a plurality of steps in order to variously change the direction and magnitude of an electric field as shown in FIG. 4, according to theoretical and programmed implementation illustrated in FIGS. 5 and 7.

The deposited electrodes of the nozzle in accordance with the present invention have a triple layered structure, and each of the three electrodes basically sets a voltage wave in each step. The fluid surface is transported to the inlet port (Step 1), the fluid is divided into small droplets (Step 2), and the droplet is instantly ejected and the varied fluid surface is returned to the state of Step 1 (Steps 3 and 4).

FIG. 8b illustrates that distribution of the electrostatic force applied to a center of the nozzle inlet is varied according each step.

Meanwhile, the present invention is capable of adapting an array-type droplet ejection method. For example, a plurality of nozzles have separate electric field directions oriented therein to supply ink or ink containing particles to each nozzle, thereby forming and ejecting a plurality of separate ink droplets.

As can be seen from the foregoing, the present invention has an advantage of readily performing droplet ejection without a heater or diaphragm vibration device.

In addition, it is possible to reduce impact applied to the ink and obtain good print quality, since the ink is ejected using the electrostatic field.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

What is claimed is:

1. A droplet ejection device comprising:
a nozzle for ejecting ink; and
a deposition part having electrode layers and insulating layers deposited toward the nozzle,
wherein each of the deposited electrode layers is connected to each separate power source to adjust a direction of an electric field.

2. The droplet ejection device according to claim 1, wherein the nozzle has a coating part comprising a hydrophilic material and a hydrophobic material continuously composed therein.

3. The droplet ejection device according to claim 1, wherein voltages applied to each separate power source is adjusted based on time to control formation and ejection of an ink droplet.

4. An array-type droplet ejection method comprising:
setting a separate electric field direction in each of a plurality of nozzles;
supplying one of ink and ink containing particles to each nozzle; and
forming and ejecting a plurality of separate ink droplets.
